(19) United States
(12) Patent Application Publication
(10) Pub. No.: US 2017/0013228 A1
(43) Pub. Date: Jan. 12, 2017

(54) Field Interviewer

(71) Applicant: Signalscape, Inc., Cary, NC (US)

(72) Inventors: Mark Edward Kalendra, Fuquay Varina, NC (US); Michael Joseph Lenzo, Cary, NC (US); Jhan Karl Vannetta, Apex, NC (US); Kyle Andrew Pennington, Apex, NC (US); Michael John D'Aurelio, Apex, NC (US); Robert Bell Dickerson, JR., Apex, NC (US)

(21) Appl. No.: 15/202,497

(22) Filed: Jul. 5, 2016

Related U.S. Application Data
(60) Provisional application No. 62/231,358, filed on Jul. 2, 2015.

(51) Int. Cl. H04N 5/77; H04W 12/06; H04N 5/76; H04N 5/225; G11B 33/02; G11B 33/06; G11B 33/12; G11B 33/10; H04L 29/06; G11B 31/00

(52) U.S. Cl. CPC H04N 5/772; H04L 65/608; H04W 12/06; H04N 5/7605; G11B 31/006; G11B 33/025; G11B 33/06; G11B 33/122; G11B 33/10; H04N 5/2252; H04W 84/12

(57) ABSTRACT

A compact portable video recording device that records when activated. A casing module contains an embedded camera that is connected to a weighted foundational support by means of a variable hinge which can be adjusted in an upward or downward position to adjust the viewing angle. The variable hinge allows the casing module to be aimed in any direction and maintain its position. At the time of activation of the portable video recording device connects using wireless communication. The video data is recorded to a removable memory and may be viewed “live” externally using wireless communication and interfacing with an external device or smart device. Adjusting the portable video recording device to a folded or “off position” stops the local video recording, ends the wireless communications and places the device in an energy conservation state.

### BACKGROUND OF THE INVENTION

1. Field of the Invention

The present general inventive concept most directly relates to conducting interviews using a compact portable video recording device. More specifically, the inventive concept relates to providing portable recording capabilities; and real-time external streaming over a wireless network. The video recording devices perform in a variety of conditions while maintaining functionality as well as maintaining a continued high level of quality, as well as being durable, portable and maintained in a simple in a compact form. The data recorded is verified and authenticated for user validation and integrity measurements.

2. Description of the Related Art

Interviews are traditionally conducted in offices and with today's progressive and changing society sometimes interviews are conducted at local coffee shops, in a local park, by criminal justice and defense individuals in the field, child services employees visiting a family home or even by an individual in the comfort of their own home, just to name a few. When interviews conducted inside and outside of the office, the notes of the interviewer are relied on to relay the information acquired during the interview. Many times these notes are then shared in order to brief others on the interview that was conducted. Capturing the interviews on video recording device alleviates the need to relying on second hand notes. Notes do not capture behavior, emotions, and sounds occurring during the interview. The need for portability has changed the market. The ability to conduct an interview from anywhere is the ideal situation. In order to accomplish this, the interviewing device must be portable, adjustable, efficient, high quality picture and sound, maintain integrity of the recordings, and provide a diverse method for displaying and accessing the data. There are numerous opportunities for use of such a compact portable video recording device in today's growing market.

Continuing advances in video recording devices, coupled with steady progress in the current demand to be less restrictive and more mobile over the past several decades, has necessitated that considerable engineering resources be devoted to improving the picture and sound quality while maintaining a convenient, compact, easy to use structure for the video recording device. The concept of creating a video recording device is generally utilized for example, mobile telephones use wireless communication and cameras. However, wireless use in the mobile phones consumes large amounts of power and power depletes quickly without recharging. This results in a battery with a fairly rapid power depletion and a video recording device with limited functionality. The constant and swift battery drain creates the need for a device with the ability to utilize the benefit wireless technology while minimizing the burden of the excessive power consumption. Balancing power consumption with allowing the portable video recording device to be compact and easily movable, is very important.

Within the portable video recording device field many cameras use a continuous recording loop of local storage to compensate for any temporary loss of network communications that might occur. This type storage does not preserve the data recording in its entirety and does not allow for an efficient mechanism for creating a reliable and storable recording. Some systems record on hard disk drives and have external cameras. This type of system is quite bulky and the use of these types of systems limit portability. In order to minimize the loss of data due to system crashes or network data loss, creating reliable storage is essential developing a dependable device. Not only must the storage be reliable, it must also be provided in a format that allows for interchangeable use, between different users, devices, and other computer readable mediums.

Many audio/visual recording devices use proxy servers that allow communication with other devices and authenticate devices for the purposes of video streaming and conferencing. The use of a proxy server can act as caching server allowing data to load faster and can mask IP addresses for anonymity; however, a proxy server use can leave the user and the video recording device open to many other vulnerabilities. A proxy server can easily be compromised and when compromised, all data is subject to theft and system integrity is degraded. This creates a need to enable secure access to a network without the use of proxy server.

There are several purposes for which the recorded data can be used, of which can include, but are not limited to evidentiary, security, confirmation, and validation, purposes. Data authentication becomes a pivotal concern. The ability to authenticate data enhances not only the value of the recorded data but also the diversification of the data use. In many existing systems, the use of captured audio/visual video device data requires the entire camera for authentication. This creates a burdensome hardship for the user, not only is the camera no longer available for use while the data is being authenticated, it is also very inconvenient and an ineffective use of resources.

Thus, there is a need in the art for a system to improve the mobility of the interviewing process. This is accomplished by the development of a system for a portable video recording device that is compact, portability, high quality audio and recordings, provides authenticated recordings, uses access point base communication; is conscientious of power consumption by minimizing power loss, accommodates for dependable storage and secures and maintains integrity of recorded data.

### SUMMARY OF THE INVENTION

The present general inventive concept provides for conducting interviews using a compact portable video recording device. More specifically, the inventive concept relates to providing portable recording capabilities; and real-time external streaming over a wireless network. The video recording devices perform in a variety of conditions while maintaining functionality as well as maintaining a continued high level of quality, as well as being durable, portable and maintained in a simple in a compact form. The data recorded is verified and authenticated for user validation and integrity measurements.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a device for a compact portable video recording device that unfolds to activate and record. The portable, pocket sized video recording device lies flat on any tabletop or surface area. The lower foundational support is weighted and is connected to a variable hinge. The variable hinge allows the portable video recording device to quickly aim and be positioned to accommodate a fluid motion for setting up the device. Upon activation of the device by unfolding, the local wireless network communication is activated and a recording can be automatically or manually activated.

The portable video recording device includes a casing module. Some of the features included in the casing module includes the camera, microphones, operational indicators functions, fill lights, microprocessors, memory, magnet switches, sensors, memory card readers, foregoing is not an exhaustive list, only a summary of the features. The casing module contains an imbedded camera that is connected to a weighted foundational support by means of a variable hinge which can be adjusted in an upward or downward position to adjust the viewing angle. The variable hinge allows the casing module to be aimed in any direction and maintain its position. The adjusting of the variable hinge creates an elevation angle which can be directed at different degrees to capture the user preferred image for the video data recording. The variable hinge elevation angle can be adjusted, aimed and positioned on any angle elevation up to the point where the casing module is in contact with the lower foundational support. This contacts initiates “off position.” In the “off positon” the recording on the portable recording device is stopped, the wireless network communication is ended and the device is placed in an energy conservation state.

While the portable video recording device is activated, the wireless network communication is activated and the recording can be automatically or manually initiated. The portable video recording device serves as an access point or client and the recording video data may be viewed “live” externally by multiple users interfacing with a wireless communication device, such as, a tablet, phone or other smart device over a wireless network. The user can not only view the recorded data but have the ability to control the data as well.

The foregoing and/or other aspects and utilities of the present general inventive concept may also be achieved by providing a computer readable medium having encoded thereon processor instructions that, when executed by a processor, performs a method of portable video recording. The processor executes processing instructions that interconnect the portable video controller and wireless communication device.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a diagram illustrating a portable video recording device and accessory component;

FIG. 2 is a side view diagram illustrating a portable video recording device;

FIG. 3 is a rear view diagram illustrating a portable video recording device;

FIG. 4 is a lower view diagram illustrating a portable video recording device;

FIG. 5 a diagram illustrating a variable hinge;

FIG. 6 is a diagram illustrating a wireless communication device.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

While specific examples are provided for portable video recording devices, the application describe herein is not limited thereto. The portable video recording device is intended to cover means to display, communicate and view interactions, typically during the conduct of an interview for the purposes of this application.

Implementation details of certain embodiments of the invention are described below by way of more specific functional components.

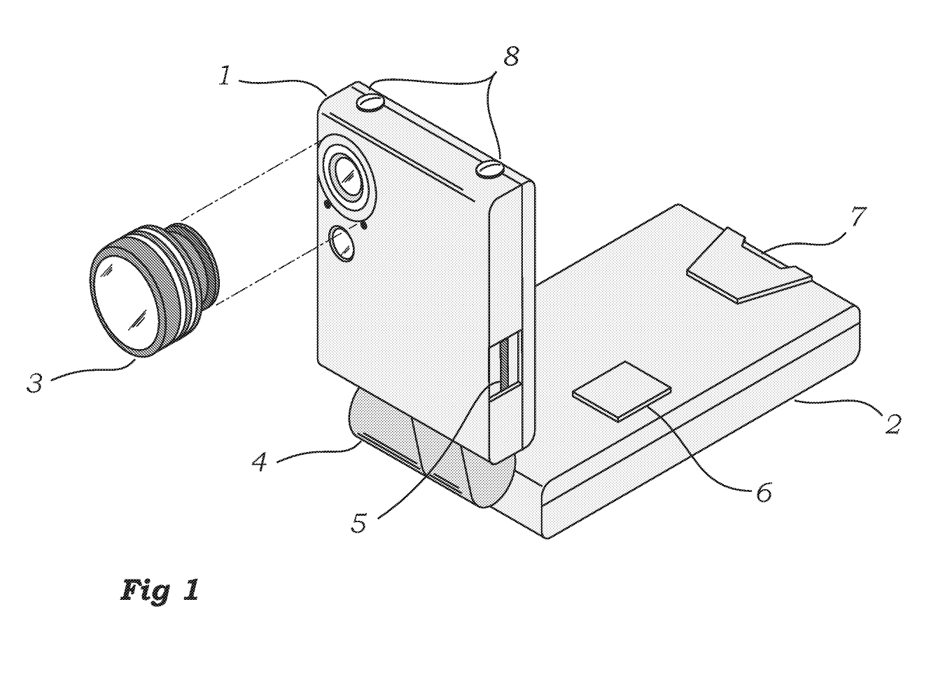

As is illustrated in FIG. 1, the present invention is composed of a portable video recording device and removable accessory lens 3 implementing a casing module 1 containing a camera and microprocessor supported by a variable hinge 4 connected to the lower foundational support 2. The casing module 1 also includes a memory card reader 5. The memory card reader 5 can hold memory cards and subsequently store recorded data onto the card. The casing module 1 supports the device operational indicators 8. These operation indicators 8 serve to determine the state of the device, which is the device's operational state. The lower foundational support 2 is weighted to assist in providing the secure foundation for the portable placement of the device. The lower foundational support 2 contains a memory card holder 7. The memory card holder 7 serves to provide a means to store extra memory cards for later use with the portable video recording device. A magnet 6 is located on the lower foundational support 2. The portable video recording device includes both audio and visual recordings. The operational indicators 8 can determine the state of the memory card in the memory card reader 5, including but not limited to a low storage or full storage indication.

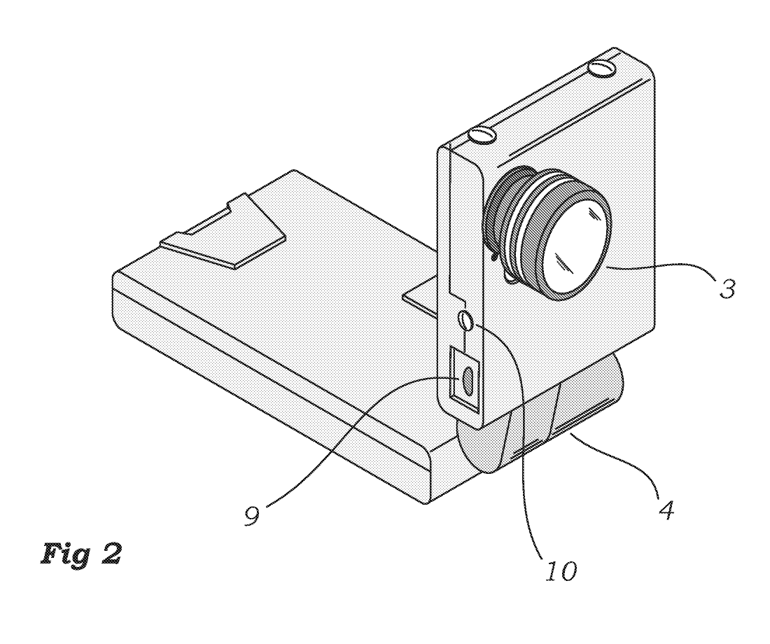

As shown in FIG. 2, all elements or components serve the same purpose as elements or components, respectively, described above with reference to FIG. 1. Additionally, FIG. 2 illustrates the portable video recording device charging port 9 connection used for power charging. A battery charging indicator 10 identifies whether the battery is charged or is in need of charging. A low battery indicator state. The charging port 9 may connect to a power source using USB to computer systems or using a power adapter connection. The removable accessory lens 3 may be attached or detached from the casing module 1.

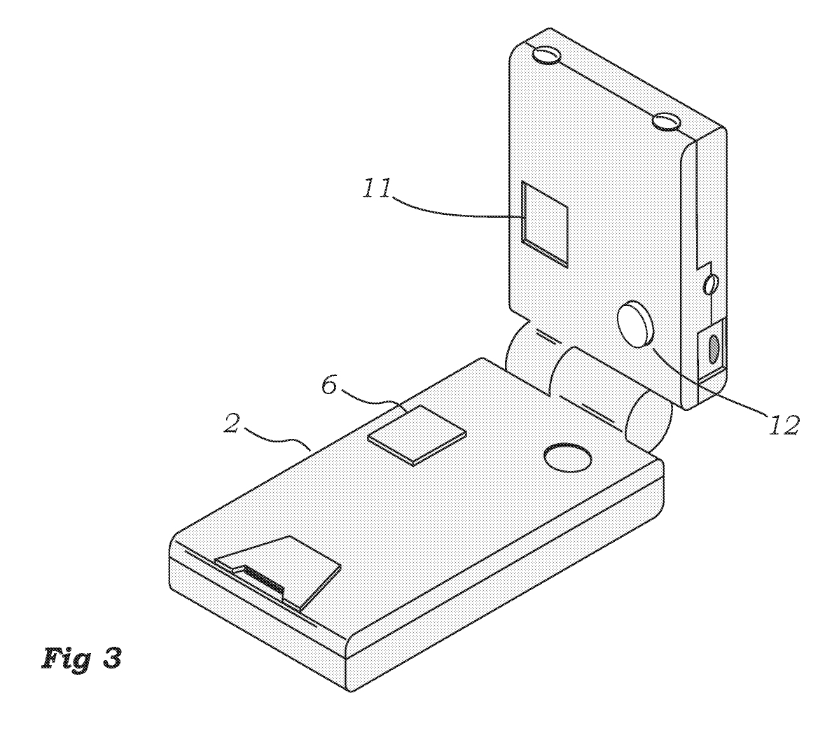

As shown in FIG. 3, all elements or components serve the same purpose as elements or components, respectively, described above with reference to FIG. 1. Additionally, FIG. 3 illustrates the rear view of the portable video recording device including an embedded magnetic switch 11 attached to the casing module 1. Also included as a part of the casing module is a start/stop button 12 to control the initiations and pausing or ending of the recordings period.

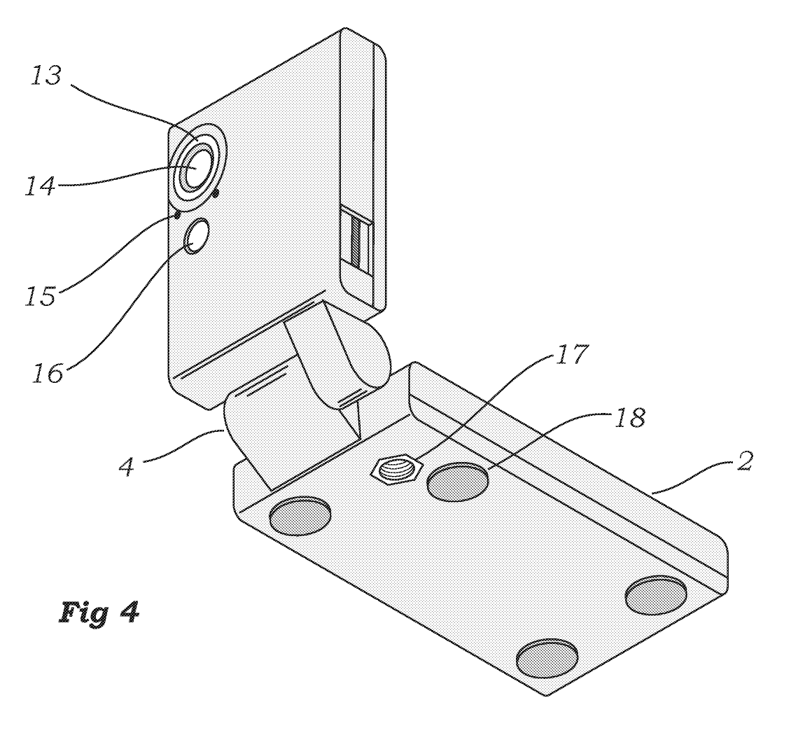

FIG. 4 illustrates a lower view of the portable video recording device. The lower foundational support uses non-slip pads 18 on the base to prevent slippage once the portable video recording device has been placed in position by the user. The portable video recording device can be placed on a table, a chair, a vehicle dashboard or any other surface able to support the device, the non-slip pads 18 serves to keep the device in place once positioned by the user. The portable video recording device can also be used with an external supporting attachment, such as a tripod stand. A mount port 17 is located on the lower foundational support 2. This mount port 17 allows for the connection of an external supporting attachment. Also depicted in the casing module 1 is a camera 14. Around the peripheral of the camera 14 is a magnetic lens mount 13. The magnetic lens mount 13 on the casing module 1 connects the removable accessory lens 3 to the casing module 1. Also found, connected to the casing module 1 are microphones 15. Stereo microphones or other sensor based microphones can be used. The quality of the stereo microphones 15 allow for clear audio signal detection and recording with minimum to no hum or high frequency loss. The sensitivity of the microphone allows capturing of whispers and faint speech. The casing module 1 supports a fill light 16 to enhance the lighting for the portable video recording device for use during the recording. In an embodiment, the fill light uses a sensor to determine need for activation and activates according. In another embodiment the fill light can be controlled remotely by the communication device or by a switch on the device.

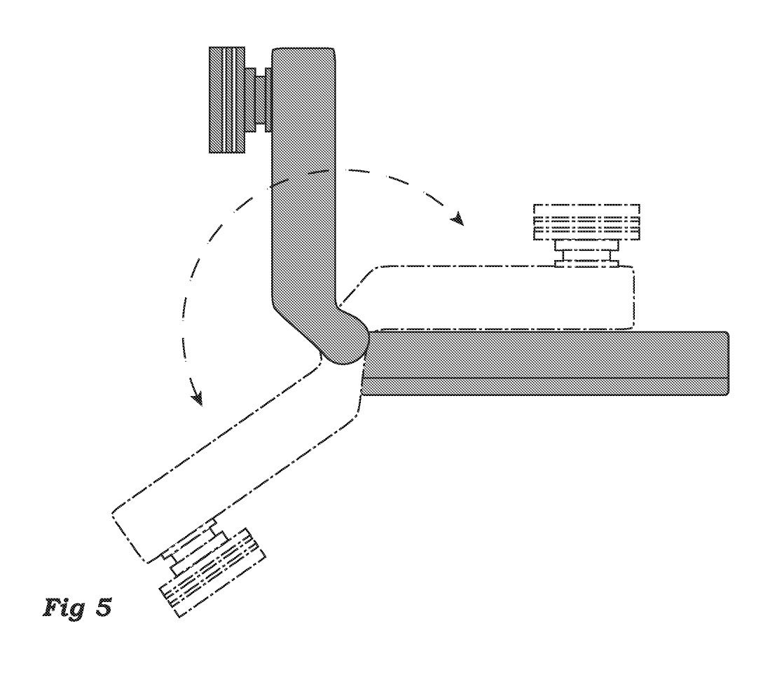

FIG. 5 illustrates a variable hinge with the portable video recording device. The variable hinge 4 allows the casing module 1 to be adjusted or aimed toward any position selected by the user relative to a stable lower foundational support 2. This allows the casing module 1 to be aimed in any position. The adjusting of the variable hinge 4 creates an elevation angle which can be directed at different degrees to capture the user preferred image for the data recording. The variable hinge 4 elevation angle can be adjusted, aimed and positioned on any angle elevation up to the point where the casing module 1 is in contact with the lower foundational support 2. The variable hinge 4 elevation angle can be adjusted, aimed and positioned on any angle elevation downward to capture an image from any position within the variable hinge rotation. The selected view can be maintained indefinitely with the variable hinge 4, without the use of external supporting attachments. The portable video recording device can be adjusted for image capture and recording in the portrait and landscape view. In each of these views the variable hinge 4 can adjusted, aimed and positioned on any elevation angle.

When the portable video recording device casing module's variable hinge 4 is positioned in its initial “off position” no recordings are taking place and the device is in a low power or off operational state. This occurs when the position of the casing module 1 is in contact with the lower foundational support 2, to the extent that there is contact between the magnet 6 and the embedded magnetic switch 11. In an embodiment a sensor system is used to identify the contact between the casing module 1 and the lower foundational support 2. The interview recording process begins when the portable video recording device casing module's variable hinge 4 is adjusted in an upward position away from the lower foundational support 2, an “unfolding position”, as in FIG. 5. This separation from the lower foundational support is considered the “on position,” an active operational state. The separation from the lower foundational support releases the contact connection of the magnet 6 from the embedded magnetic switch 11. Once the release has occurred the portable video recording device will activate and recording can be initiated automatically or manually, in an active recording operational state. The direct contact between the magnet 6 on the lower foundational support 2 and the embedded magnetic switch 11 on the casing module 1 will stop the recording process. The disengaging of the contact between the magnet 6 on the lower foundational support 2 and the embedded magnetic switch 11 on the casing module 1 will activate the device and allow the recording process to initiate automatically or manually.

The portable video recording device also controls the recording process through the use of the start /stop button 12. When the portable video recording device is in its “on position” the recording device is active. When it is desired to start, pause or otherwise stop a recording while the portable video recording device is still in its “on position” the start/stop button 12 may be pressed and the current recording can be stopped or started based on the desires of the user. The operational indicator is in an active state.

When the portable video recording device is in the “off position” it is powered down. The portable video recording device also uses a low power and a sleep operational state. These states of operation assist in preserving the battery power of the device.

The casing module 1 includes a microprocessor. The microprocessor within the casing module 1 performs video compressions. In another embodiment the video compression can be implemented using separate hardware located in the camera module or alongside the microprocessor. The memory used by the microprocessor is used to execute the computer readable instructions. The casing module which also includes the camera 14. When the camera 14 is recording the operation indicator 8 will light, indicating the recording is underway, representing the active recording indicator state. The operational indicator 8 may be visual or audio, such as an LED or other indicating light or notification indicator of the video recording device recording activity.

In another embodiment the portable video recording device may operate as a Wi-Fi access point or a client on a local or enterprise Wi-Fi network. The portable video recording device has an access point mode and client mode. In this embodiment, the default state of the portable video recording device is to operate as a standalone access point. As a standalone access point, the portable video recording device is capable of providing the means for a client smart device or other external device to connect directly for video and audio streaming. The portable recording device exchanges operational command and operational control information using a wireless or network transmission. The communication of the video and audio streaming data is capable of real-time video and audio transmission to the client smart device or other external device. The portable video recording device is capable of automatic selection of the client or access point mode based upon the availability of the selected external network. The external network may be a local or enterprise network. When the external local or enterprise network is available, the portable video recording device will connect to the external network by default. This is the client mode. When the external network is not available or is out of range the portable video recording device will automatically switch to access point mode and provide a standalone network for the client smart device or another external device to use. The portable video recording device is configured to connect to local area or enterprise Wi-Fi network access point. The portable recording device is also capable of acting as a client on an alternate network rather than a standalone access point.

The memory card reader 5 utilizes removable memory cards. For example, Micro SD Flash cards may be used. The card is inserted from outside of the portable video recording device into the memory card reader 5. This makes the stored data located on the memory card easily accessible and provides a simple means of archiving data. The use of the memory card with the memory card reader 5 allows the portable video device to preserve the data recordings until the user chooses to remove them from the portable video recording device. This feature is an asset should the chain of custody of recorded data be deemed necessary, only the memory card would be required and not the entire portable video recording device. This approach also provides proper storage of recorded data for easy access by the user.

The recorded data is watermarked. The recorded data is also stored on the memory card located in the memory card reader 5. The watermarking can include visible video watermarks, such as, but not limited to date, time, name, location, and authentication code. The authentication process uses an identifier for the watermarked video recordings. The identifier is displayed to the user.

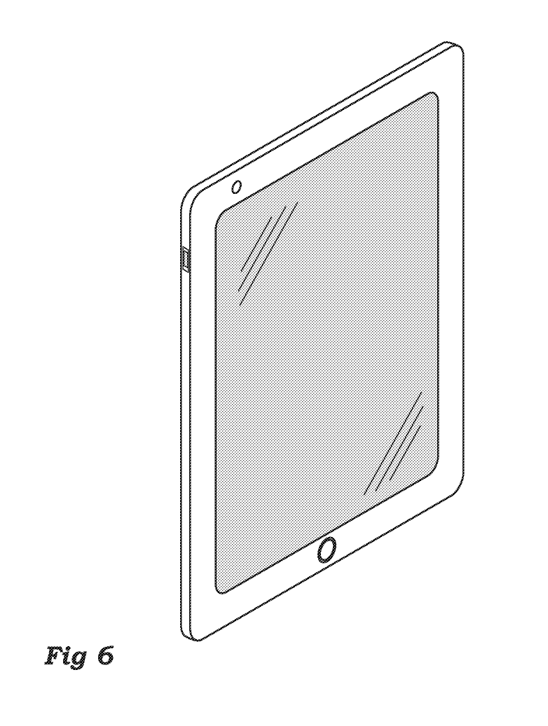

The portable video recording device communicates with wireless communication devices such as, but not limited to, tablets, PDAs, cellphones, smart devices or laptops, as depicted in FIG. 6. The wireless communication used in connection with the wireless communication devices using WiFi network streaming. The wireless communication between these wireless communication devices and the portable video recording device is direct. The portable video recording device serves as a wireless access point and allows the communication devices to connect to the access point functionality. When the portable recording device is activated in the “on position” the internal access point turns on. When the user adjusts the portable video recording device to the “off position” the internal access point turns off and the WiFi is powered down and wireless communication is no longer available. When the video recording device is activated in the “on position” a user can connect to the portable video recording device using WiFi from the wireless communication device and control the portable video recording device from the wireless communication device.

The wireless communication device allows the user to view the recorded data from the portable video recording device. The wireless communication device, as depicted in FIG. 6, interfaces with the portable video recording device through a wireless connection. The user is able to view the interview taking place in real-time. In addition to viewing the recorded content on the wireless communication device's screen, the user is also able to control the portable video recording device from the wireless communication device. Control of the device includes but is not limited to adjusting setting features, resolution, pictures, zoom features, starting, stopping and pausing the recordings, bookmarking, file naming and file management, and cataloging files. Once an interview is completed the user can use the wireless communication device to bookmark, catalog for file management, and export the file for different uses, such as, but not limited to, evidentiary purposes, DVD creation, sharing with other devices or authentication. The portable video recording device accommodates multiparty engagement for wireless viewing of a recording interview, the authentication watermarking can be viewed by all users and all users have the capability to bookmark while collaborating on external wireless communication devices. This allows user the functionality of remote monitoring of live interviews via web browser from any PC on a local network.

Certain embodiments of the present general inventive concept provide for the functional components to manufactured, transported, marketed and/or sold as processor instructions encoded on computer-readable media. The present general inventive concept, when so embodied, can be practiced regardless of the processing platform on which the processor instructions are executed and regardless of the manner by which the processor instructions are encoded on the medium.

It is to be understood that the computer-readable medium described above may be any medium on which the instructions may be encoded and then subsequently retrieved, decoded and executed by a processor, including electrical, magnetic and optical storage devices, and wired, wireless, optical and acoustical communication channels. The computer readable medium may include either or both of persistent storage, referred to herein as “computer-readable recording media” and as spatiotemporal storage, referred to herein as “computer-readable transmission media”. Examples of computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The computer-readable recording media may be distributed across components, to include such distribution through storage systems interconnected through a communication network. The computer-readable transmission media may transmit encoded instructions on electromagnetic carrier waves or signals, or as acoustic signals through acoustically transmissive media. Moreover, the processor instructions may be derived from algorithmic constructions of the present general inventive concept in various programming languages, the mere contemplation of which illustrates the numerous realizable abstractions of the present general inventive concept.

The descriptions above are intended to illustrate possible implementations of the present invention and are not restrictive.

What is claimed is:

1. A portable video recording device comprising:
a casing module;
a variable hinge directionally adjustable to a plurality of angles;
a foundational support;
a camera;
a microphone;
a microprocessor;
a wireless networking device; and
at least one operational indicator;
said camera, microphone and microprocessor are housed within the casing module;
the variable hinge connects the casing module to the foundational support;
said variable hinge aims at a variable angle toward a selected position; and
said operational indicator indicates an operational state.

2. A portable video recording device wherein the casing module and the lower foundational support are in contact in a low power or off operational.

3. A portable video recording device as recited in claim 1, wherein the casing module and the lower foundational support are not in contact in an active or active recording operational state.

4. A portable video recording device as recited in claim 1, wherein the foundational support is weighted.

5. A portable video recording device as recited in claim 1, wherein the casing module is capable of receiving a memory card, said casing module is capable of reading and storing recorded data onto said memory card.

6. A portable video recording device as recited in claim 1, wherein the foundational support is capable of receiving at least one memory card.

7. A portable video recording device as recited in claim 1, wherein the foundational support includes a magnet.

8. A portable video recording device as recited in claim 1, wherein the casing module includes a magnetic switch.

9. A portable video recording device as recited in claim 1, wherein the casing module includes a battery charging port, at least one operational indicator, said operational indicator indicating the power status of a battery.

10. A portable video recording device as recited in claim 1, wherein the casing module includes a button capable of initiating, pausing, and ending the recording.

11. A portable video recording device as recited in claim 1, wherein the casing module includes a sensor and a light.

12. A portable video recording device as recited in claim 1, wherein the foundational support includes the battery.

13. A portable video recording device as recited in claim 1, wherein the operational indicator includes an LED indicating the state of the device, the battery charge, the recording state, and memory card state.

14. A portable video recording device as recited in claim 1, wherein the operational indicator includes an active, active recording, low battery, and low storage states.

15. A portable video recording device as recited in claim 1, wherein the wireless networking device is capable of wireless communication with external devices;
said wireless communication is enabled in the active state, said wireless networking device is capable of transmitting real-time video to an external device;
said wireless networking device is capable of transmitting real-time audio to an external device; and
the microprocessor is capable of exchanging operational command and control information through wireless transmission with the external device.

16. A portable video recording device as recited in claim 1, wherein the camera housed within the casing module has a magnetic lens mount capable of receiving a removable lens.

17. A portable video recording device as recited in claim 1, wherein said foundation support has a mount port capable of receiving an external attachment.

18. A portable video recording device as recited in claim 1, wherein said microprocessor through the wireless networking device capable of exchanging operational commands from the external device.

19. A portable video recording device comprising:
a casing module;
a variable hinge directionally adjustable to a plurality of angles;
a foundational support;
a camera;
a microphone;
a microprocessor;
a wireless networking device; and
at least one operational indicator;
said camera, microphone and microprocessor are housed within the casing module;
the variable hinge connects the casing module to the foundational support;
said variable hinge aims at a variable angle toward a selected position;
said operational indicator indicates an operational indication state;
said wireless networking device is capable of wireless communication with external devices;
said wireless networking device is capable of transmitting real-time video to an external device;
said wireless networking device is capable of transmitting real-time audio to an external device;
said microprocessor is capable of exchanging operational command and control information through wireless transmission with the external device;
said wireless networking device functions as a Wi-Fi access point for communication with external device;
said wireless networking device is selectively configured to act as a client on a local or enterprise Wi-Fi network; and
said wireless networking device defaults to access point functionality when the local or enterprise Wi-Fi network is not available.

20. A non-transitory computer-readable medium having stored thereon computer-readable instructions that when executed by a computing device cause the portable video recording device to:
receive video and audio data requests from an external device wherein the microprocessor and the external device are communicating over wireless communication;
evaluate the video and audio data request from said external device or client smart device, based on the ability of the external device or client smart device capability to decode the video and audio data;
authenticate the video and audio data request from said external device from the external device or client smart device;
identify the availability of an external network;
automatically select a client or access point mode for communication;
transmit the video and audio data to the external device or client smart device;
configure the wireless networking device as a client on a local or enterprise Wi-Fi network; and
secure the wireless networking device in the access point mode, where the local or enterprise Wi-Fi network is not available.
